(19) United States
(12) Patent Application Publication
(10) Pub. No.: US 2014/0024011 A1
(43) Pub. Date: Jan. 23, 2014

(54) Method for Preparing Adipose Tissue

(71) Applicant: AdiCyte, Inc., Tucson, AZ (US)

(72) Inventor: David Thomas Harris, Tucson, AZ (US)

(21) Appl. No.: 13/948,842

(22) Filed: Jul. 23, 2013

Related U.S. Application Data
(60) Provisional application No. 61/674,635, filed on Jul. 23, 2012.

(51) Int. Cl. A01N 1/02

(52) U.S. Cl. CPC A01N 1/0284
USPC 435/1.3; 435/325

(57) ABSTRACT

This disclosure presents methodologies for processing, cryogenic storage, retrieval and preparation of a tissue for transplantation. As such, the methods provide a system by which tissue for transplantation can be reliably and safely processed and stored for an extended period of time until the tissue is desired to be used.

### BACKGROUND OF THE DISCLOSURE

Use of autologous tissues, such as adipose tissue, for re-introduction into a patient, is useful in many types of reconstructive and other surgeries where autologous transplantation is desired. However, standard techniques are limited to tissue removal followed by re-introduction of tissue into the patient immediately or within at most a few hours. A reliable and clinically feasible method for successful long-term cryopreservation and storage of tissue has not been established (Pu, Organogenesis 5:138-142, 2009). Further, no reliable and clinically feasible method has been established that allows medical practitioners to remove tissue, send it to a facility for an indefinite period of storage, and receive tissue ready for transplantation into a patient.

### BRIEF SUMMARY OF THE DISCLOSURE

This disclosure presents methodologies for processing, storage, thawing and preparation of a tissue for transplantation. As such, the methods provide a system by which tissue for transplantation can be reliably and safely processed and stored for an extended period of time, in a manner that maintains tissue viability, until the tissue is desired to be used. The preferred tissue is adipose tissue.

The methods for processing and storage of a tissue include removing a tissue sample from a subject, adding cryoprotectant to the sample, freezing the sample, and storing the sample in liquid nitrogen.

When it is desired to retrieve the sample from storage, the sample is thawed, any cryoprotectant is removed, and then the sample can be washed and prepared for transplantation into a subject. The sample can be transferred into one of more syringes for transplantation into a subject. After the steps of the methods as provided herein are performed, the sample is ready for transplantation into a subject with no further processing or preparation of the sample.

When it is desired to process and store the tissue at a storage facility separate from where the tissue removal occurs, the methods above provide that the step of removing the tissue sample from said subject occurs at a medical facility, and the sample is transported from said medical facility to a storage facility where it is processed, frozen and stored. Further, when it is desired to transplant the tissue, the sample is transported from the storage facility to a medical facility for transplantation into the same or a different subject.

Accordingly, this disclosure further provides adipose tissue prepared by the methods of the invention, and a syringe containing adipose tissue prepared by the methods of the invention.

### BRIEF DESCRIPTION OF THE FIGURE

FIG. 1. Example of tubing connection for storage process.

### DETAILED DESCRIPTION OF THE DISCLOSURE

There is an existing need for an operable, efficient, highly consistent system for freezing (or other method for preserving viable tissue), storing, thawing, and delivering tissue, preferably adipose tissue, in a manner ensuring viability and sterility of the adipose tissue for transplantation into a subject. Medical practitioners, such as cosmetic surgeons and other doctors that require storage of tissue remotely or for retrieval at a later time, desire a system that would enable “hands-free” (for the doctor) processing and storage of patient-derived adipose tissue, where such tissue could be returned to the practitioners ready to re-introduce into a patient. This disclosure provides a complete methodology for achieving these goals. This disclosure further provides adipose tissue, and syringes containing adipose tissue, prepared according to the methods of the invention.

As used herein, the terms “subject” and “patient” are used interchangeably and refer to an animal, preferably a mammal such as a non-primate (e.g., cows, pigs, horses, cats, dogs, rats etc.) and a primate (e.g., monkey and human), and most preferably a human. As used herein, the term “transplantation” refers to any type of transplantation or implantation whether autologous, homologous or heterologous. As used herein, the term “cryoprotectant” means a chemical that minimizes ice crystal formation in a tissue or organ when the tissue or organ is cooled to subzero temperatures and results in an increase in viability after warming, in comparison to the effect of cooling without cryoprotectant. Cryoprotectants include, but are not limited to, dimethyl sulfoxide, formamide, 1,2-propanediol, 2,3-butanediol, glycerol, ethylene glycol, n-dimethyl formamide and 1,3-propanediol. Impermeable chemicals with demonstrated cryoprotective activity include agarose, dextrans, glucose, methyl glucose, hydroxyethylstarch, inositol, lactose, polyvinylpyrrolidone, sorbitol, sucrose and urea. The vehicle for the cryoprotectant solution may be any type of solution that maintains cellular integrity under in vitro conditions. In particular, the vehicle generally comprises slowly penetrating solutes. In a preferred embodiment, the vehicle solution is phosphate buffered saline (PBS) containing 1-6% (v/v) final concentration human serum albumin (HSA). PBS may be included in any effective amount. In addition, other buffers, as well as no buffer, may be used.

In a preferred embodiment, the tissue is adipose tissue. However, the methods and processed tissues disclosed herein can be utilized in, and result from, cryopreservation and storage of other tissues, organs and cell types, both for surgical and non-surgical uses.

### Procedure

The first steps in the method involve isolation and preparation for freezing and storage of a tissue for transplantation. The steps include removing a tissue sample, preferably adipose tissue, from a subject, adding cryoprotectant to the sample, freezing the sample, and storing the sample in liquid nitrogen.

As a first step in the process, adipose tissue is removed from a subject. The removal can be by any surgical means so long as sterility of the sample is not compromised, for example, suction-assisted removal or other surgical methods. The adipose tissue sample is placed in one or more sterile containers, such as a syringe (10 ml to 60 ml), test tube, or other sample container.

In a particular embodiment, the sample is removed from a subject at a suitable medical establishment, such as a doctor's office or other medical facilty, and the sample can be then transported to a tissue storage facility for processing, freezing, storage, thawing, and preparation for transplantation. Alternatively, tissue storage can be provided at the same medical establishment at which the sample is removed, and the sample is simply transferred to the appropriate processing and storage area within the medical facility.

Where the sample is to be shipped from one location to another, the container containing the tissue sample is placed on ice after removal, and refrigerated if not immediately prepared for transfer to a storage facility. The sample can be shipped at room temperature or preferably on wet ice to a processing and storage facility and should arrive within 48 hours of preparation for shipping. Once the sample is received by the storage facility, the sample can be prepared for freezing and storage according to the following protocol.

The total volume of the sample can be estimated to determine the amount of cryopreserative to add to the sample. For samples received in syringes, the sample volume can be determined by examining the syringe volume taken up by the tissue and liquid in each syringe, excluding airspace. Alternatively, the sample volume can be estimated by weighing the container containing the sample (in grams or ounces) as long as the balance is tared to compensate for the weight of the container.

The sample is preferably processed in a tissue culture hood containing clean container(s), 70% ethanol, cryostorage containers, and autoclaved paper towels. The tissue culture hood can be a class II laminar air flow hood.

One or more cryostorage containers can be used to store the sample for freezing. The cryostorage container can be a bag, tube, or any container of suitable size and material to hold the sample during storage.

The size of the cryostorage container can be determined based on sample size (Table 1). Preferred containers are cryobags with tubing connections, such as CRYOSTORE™ freezing bags and tubing connections (OriGen Biomedical, Austin, Tex.). The container can be labeled with appropriate patient specific labels, such as subject name or assigned number.

TABLE 1
Approximate container and freeze volume per sample size

| Sample size | container | total freeze volume (including cryoprotectant) |
|---|---|---|
| 5-15 ml | 50 ml | 10-30 ml |
| 35-50 ml | 500 ml | 70-100 ml |

Prior to placing the adipose samples into the cryobags for freezing and storage, the sample can be washed one or more times, preferably three to five times, with sterile phosphate buffered saline (PBS), and each wash can be kept and combined to obtain cells.

The cellular fraction from the one or more washes can be used to perform one or more of the following tests on the adipose sample: (1) cell number (estimation based on volume and/or weight of sample); (2) cell viability (as measured by any means such as by Trypan dye exclusion); (3) sterility (as measured by any means such as by microbial plate testing); and (4) mesenchymal stem cell/multipotent stromal cell colony forming units-fibroblast or CFU-F (as measured for example by CFU-F assay, see Freidenstein A J et al., Cell Tissue Kinet. 3:393-403, 1970). These data can be entered onto a data collection sheet (DCS) for review.

The samples can be collected in any sterile container, such as a sterile syringe. For convenience of transfer into a cryostorage container such as a cryostorage bag, it is preferred that the sample be contained in a syringe, such as a 10 or 60 cc syringe. The sample can be centrifuged at room temperature at 300 g for 5 minutes.

### Processing for Cryopreservation

Inside the tissue culture hood, the cryopreservation container (cryobag) can be inverted and held with syringe outlet on top. The collection syringe is held with the plunger on the bottom. Fatty tissue will float to the top leaving fluid on the bottom. Any air inside the syringe is maintained at the very top of the syringe.

The cap can be removed from the syringe and any air expelled. The syringe can be connected to one of the luer locks on the cryobag with the “roller lock” open allowing free flow through the tubing. The remaining luer lock can be capped and the “roller lock” kept completely down to close off the unused tubing.

The syringe plunger is depressed to expel all of the syringe contents. If there is more than one syringe, the first syringe can be removed and the previous steps are repeated with any remaining sample syringes until the entire sample has been expelled from the syringe(s). Adipose tissue should enter the tubing first as it is nearest the syringe opening. The remaining fluid (that flows last) will fill the tubing from the syringe to the bag.

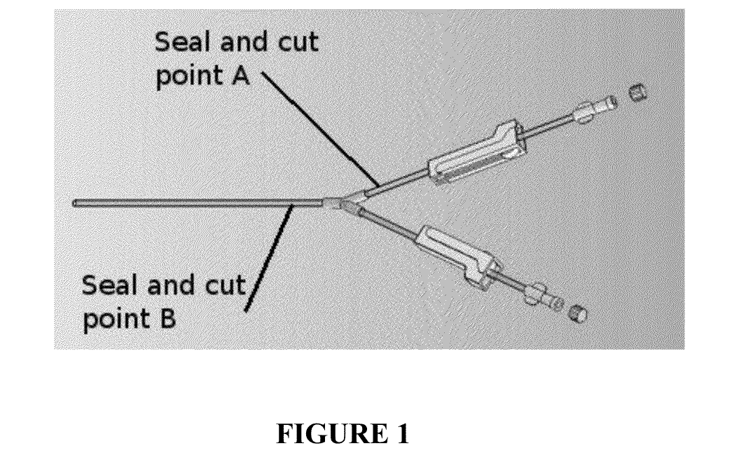

Using the tube sealer, the tube can be sealed and cut at a point “A” as shown in FIG. 1, just next to the “Y” connector, between the roller lock and the “Y” connector. The cut off section then consists of the empty syringe and approximately 10 cm of tubing filled with fluid from the sample collection. This section can be saved for viability and sterility testing upon thawing. The empty syringe is discarded.

The cryobag with tissue sample is placed in 4° C. refrigeration for 10-30 minutes to ensure the sample is sufficiently cooled.

The sample is infused with cryoprotectant media prior to freezing. Dimethyl sulfoxide (DMSO), the preferred cryoprotectant for preservation, can shock and kill cells if added too quickly to a sample. Therefore, a syringe or infusion pump can be used to slowly add cryoprotectant media with DMSO to the sample, maintaining a constant rate of infusion to maximize cell viability. The cryoprotectant media can contain from 1% to 20% DMSO (v/v).

The amount of cryoprotectant to be used can be the same volume as the sample size. Preferred cryoprotectant media is composed of sterile PBS containing 2-5%, preferably 5% (v/v) final concentration human serum albumin (HSA), and 1-20%, preferably 10% (v/v) final concentration DMSO. A syringe can be filled with an amount of cold 10% DMSO cryoprotectant media equal to the estimated sample size and placed into 4° C. refrigeration until ready for use.

The syringe containing cryoprotectant, and the cryobag containing the sample, are removed from refrigeration and returned to the tissue culture hood. The syringe is connected to the luer on the cryobag and the full volume of cryoprotectant media is expelled into the cryobag. The tubing is sealed and cut at point “B” as identified in FIG. 1.

Alternatively, using syringe or infusion pumps, the cryobags can be connected to a reservoir of DMSO freezing media which can be added slowly, either in a cold room or at room temperature with the cryobag sandwiched between ice packs. The sealed bag can be placed on an orbital shaker in 4° C. refrigeration for at least 10 minutes.

The bag is placed on a bag hanger with the tubing at the bottom. A tube stripper can be used to evacuate the tubing of the DMSO-cryomedia and allow mixing with the bag contents. This step can be repeated, for example by inverting or stripping the bag one or more additional times, and the mixed sample is allowed to flow back into the tube. The sealed bag can be placed back on the orbital shaker in 4° C. refrigeration for a minimum of 10 minutes.

The bag can be removed from the orbital shaker and the tubing can be sealed at a point near the cryobag. The remaining tubing can be sealed in the middle of the section, making two sealed-off tubing sections of approximately 5-6 cm each. The cryostore bag can be further placed into a labeled overwrap, and cryostore bag can be sealed inside the overwrap bag leaving as little air inside the overwrap as possible. Preferred overwrap bags are CRYOSTORE™ cryopreservation bag overwrap bags (OriGen Biomedical, Austin, Tex.). The bag can be further placed into a freezing cassette or other freeze-safe, puncture-proof container suitable for use in liquid nitrogen storage, preferably with the patient label visible through the window. Loaded cassettes are placed into a freezer.

A programmable controlled-rate freezer with chart recorder is preferably used for the cryopreservation process. Prior to placement of the sample into the controlled-rate freezer it can be decontaminated with a decontaminant such as 10% bleach-in-water solution. Hard copies (and electronic copies, if available) of each freezing run are archived. The printout of the freezing run can be stored with the worksheets for each sample. A computer copy of the freezing run stored with the other patient data in the data base is also desirable.

The cell freezer utilizes a thermocouple probe placed on (or in) the sample. The controlled-rate freezer is preferably cleaned and decontaminated prior to and after each freezing run. The controlled-rate freezer should be calibrated and validated annually.

The sample is frozen to −90° to −140° C., preferably to −140° C. The cryopreservation protocol is preferably as follows: −1° C./min cooling down to −5° C. followed by a rapid decrease (−25° C. degrees/minute) down to −50° C., a temperature increase (+15° C. degree/minute) to −12° C. followed by a −1° C./min drop to −40° C., and a −10° C./min drop to −140° C. It is understood by the skilled artisan that this freezing protocol can be modified at any or all of these steps so long as cell viability is maintained.

### Storage

When the freeze run is complete, freeze cassettes are removed and loaded into frames for storage. The samples are maintained at −150° C. to −200° C., preferably −180° C., by any suitable means for cryostorage such as in liquid nitrogen, preferably in a liquid nitrogen dewar. The frame can be placed into final storage position in the dewar, as assigned manually or with use of the computer data base. Samples can be stored indefinitely. Samples can be stored indefinitely (for at least 1 to 10 weeks, or for at least 1 to 10 months, or at least 1 to 10 years).

### Thawing

This disclosure further presents methods for removing the sample from storage, thawing the sample, removing the cryoprotectant from the sample, and preparing the sample for transplantation into a subject. According to these methods, the freezing cassette containing the cryobag is first removed from storage. The bag can be left in the cassette until just before the thawing procedure begins. If the bag cannot be easily removed from the cassette, the cassette can be warmed enough to allow sufficient thawing of the cassette to remove the bag with ease. The cryobag inside the overwrap bag (and the cassette if necessary) can be thawed by hand in an approximately 36-40° C. water bath containing any standard disinfectant, or using hot water from a faucet.

Preferably, the cryobag is thawed in a water bath that is cleaned, disinfected, and heated to 38° C.±2°. Sterile water is recommended. The bag can be placed in the warming bath without complete immersion, as the ports on top of the bag preferably should remain outside or above the water.

The cryobag can be gently massaged while it is warming to reduce temperature differences within the bag. During warming, the bag should be watched for any problems, such as breakage, leakage or swelling. Swelling can indicate liquid nitrogen infiltration. If swelling occurs, the spike port can be punctured to release pressure and prevent bursting. Maintaining an aseptic technique in the event of bag puncture can prevent compromising the sample.

The bag can be considered thawed when no ice crystals remain in the bag. Once the last ice crystals have melted, the bag can be removed from the warming bath. It is preferably removed from the water bath immediately upon thawing, as the cryoprotectant may alter cell viability at elevated temperatures. The cryobag can be wiped with an alcohol wipe upon removal from warming bath. In particular, the spike port area must be thoroughly cleaned with alcohol and/or sterile wipes. The cryobag is then placed on ice or kept at 2°-6° C. once thawed.

### Removal of Cryoprotectant and Preparation for Transplantation

The following work is preferably done in a cold environment (cold room or on ice) immediately upon thawing of the sample.

Ice cold 5% HSA saline solution is prepared prior to or during thawing of the cryostorage container containing the sample. The 5% HSA saline solution can be administered to the cryostorage container by any means, such from a tube, flask, syringe, or other sterile container. For samples frozen in a cryobag, syringes provide a convenient method to administer the saline solution to the sample.

Preferably, one or more 25 cc to 100 cc syringes, such as a 60 cc syringe, is utilized to administer the saline into a cryobag. The syringe or syringes can be kept refrigerated or on ice until ready to use. The cold 5% HSA solution is injected (25-100 cc) into the cryobag, the bag is inverted several times to mix the contents, and then turned upside down. The same syringe can be then used to remove the liquid from the bag (adipose tissue and cells will float to the top), and the process can be repeated using room temperature (approximately 25° C.) 5% HSA solution. The sample can be washed 2-5 times in total with the room temperature 5% HSA saline solution. An equal volume of “transport buffer”, such as 1-5% lactated Ringer's solution, or a comparable buffered physiologic solution, containing 1-2% HSA (for example, 10 cc of solution to 10 cc of sample) is then added and mixed well. The sample can be then removed from the bag access port using one or more syringes, such as 60 cc syringes.

The sample can be transferred into one or more containers for centrifugation, such as 20 cc syringes using sterile luer-loc adapters, and these containers are centrifuged at room temperature at 300 g for 2-7 minutes, preferably 5 minutes.

The oil layer on top can be decanted, while the red blood cell (RBC) layer on the bottom can be expelled. The “enriched fat layer” (middle fraction) can be retained in the cc syringe. Using a sterile luer-loc adapter the “enriched fat fraction” can be transferred in lcc aliquots into sterile lcc syringes such as tuberculin syringes. A locking syringe cap is preferred to prevent leaking of the sample.

### Record-Keeping and Sterility

One aspect of the system according to the present invention that improves the consistency of the methods is detailed record-keeping of the processing of each sample. Preferably, at least two of the following are recorded for each sample: the date of receipt of the sample; the subject name or number; the estimated sample weight; the estimated cell number, the tested cell viability, the tested sterility of the sample; the actual freezing parameters; the date the sample is frozen; and the date the sample is thawed.

Another aspect of the system according to the present invention involves use of sterile equipment, sterile containers, sterile media, routine disinfection of all surfaces, and sterile technique, whenever feasible. It is preferred that each step in the methods provided herein is performed in a sterile environment, under sterile conditions, to minimize sample contamination and maximize safety of the transplanted tissue into a subject.

### Delivery to Medical Personnel for Transplantation

Tissue storage and preparation for transplantation can be performed on site at the medical facility where the tissue is to be provided to a recipient. In this case, once the sample is thawed and prepared for transplantation according to the methods provided herein, the sample is provided to a medical practitioner for transplantation.

When the sample is stored at a tissue storage facility off site from the medical facility where the sample will be transplanted, the sample must be transported to the medical facility, for example by shipping the sample to the facility. Shipment is preferably by overnight service, such as Federal Express or Quick Courier service, at the doctor's discretion.

The sample can be transported in a cryogenically frozen state without thawing or processing. In this case, the thawing and preparation steps according to the methods described herein are performed once the sample has reached its destination. For shipment, following the removal of the cryogenic sample from the liquid nitrogen storage dewar, the sample is decontaminated, and placed in either liquid nitrogen (or a liquid nitrogen dry shipper) or on dry ice (−80° C.) for transport. The sample preferably arrives at the medical facility in a cryogenic state within 48 hours of leaving the storage facility.

Alternatively, thawing and preparation of the sample can occur prior to transportation. If the sample is thawed and prepared prior to being transported to a medical facility, the sample can be prepared for transport as follows. 20 cc syringes filled with 10 cc of the “enriched fat layer” and 10 cc of the transport buffer are placed in a transport bag such as a self-sealing “blue-line” bag, 1 syringe per bag, and placed on “wet ice” for transport. The syringes on ice are placed into the insulated and padded shipping container for shipment to the clinical site. The thawed and prepared sample preferably arrives on “wet ice” within 36 hours of leaving the storage facility. Once the syringe or syringes containing the tissues are received by the doctor, they are placed at room temperature in an inverted position for 10 minutes, the transport buffer is removed and the samples is then ready for immediate transplantation into the patient, with no further processing necessary.

What is claimed is:

1. A method for maintaining viability of a tissue for transplantation, comprising removing a tissue sample from a subject, adding cryoprotectant to the sample, freezing the sample, and storing the sample in liquid nitrogen.

2. The method of claim 1, wherein said tissue is adipose tissue.

3. The method of claim 1, wherein the cryoprotectant is sterile phosphate buffered saline solution (PBS) containing 3-6% (v/v) human serum albumin (HSA) and 10% (v/v) dimethyl sulfoxide (DMSO).

4. The method of claim 1, wherein the sample is placed in a cryostorage container prior to freezing the sample.

5. The method of claim 4, wherein the cryostorage container is a cryobag.

6. The method of claim 1, wherein the sample is frozen to −140° C.

7. The method of claim 6, wherein the freezing process comprises:
i. cooling the sample to −5° C. at a rate of −1° C. per minute;
ii. cooling the sample to −50° C. at a rate of −25° C. per minute;
iii. heating the sample to −12° C. at a rate of +15° C. per minute;
iv. cooling the sample to −40° C. at a rate of −1° C. per minute; and
v. cooling the sample to −140° C. at a rate of −10° C. per minute.

8. The method of claim 1, further comprising removing the sample from storage, thawing the sample, removing the cryoprotectant from the sample, and preparing the sample for transplantation into a subject.

9. The method of claim 8, wherein the sample is thawed in a 38° C. water bath, and the sample is kept at 2°-6° C. subsequent to thawing.

10. The method of claim 8, wherein after the cryoprotectant is removed, the sample is washed with saline and maintained in a buffered physiologic solution.

11. The method of claim 10, wherein said sample is washed at least once with ice cold saline comprising 1-6% (v/v) human serum albumin (HSA), and then washed at least once with room temperature saline comprising 1-6% (v/v) HSA.

12. The method of claim 10, wherein the buffered physiologic solution is lactated Ringer's solution comprising 1-6% (v/v) human serum albumin (HSA).

13. The method of claim 8, wherein the step of preparing the sample for transplantation comprises transferring the sample into one or more syringes.

14. The method of claim 13, wherein said sample is centrifuged to separate layers of cellular material before or after transferring the sample into one or more syringes.

15. The method of claim 13, wherein once the sample is transferred to one or more syringes, the sample is ready for transplantation into the subject.

16. The method of claim 1, wherein the step of removing the tissue sample from said subject occurs at a medical facility, and said tissue sample is transported from said medical facility to a tissue storage facility for freezing and storage.

17. The method of claim 16, wherein the cryogenically frozen sample is transported from the tissue storage facility to a medical facility.

18. The method of claim 13, wherein the sample is frozen, stored, thawed, and prepared for transplantation at a tissue storage facility, and said one or more syringes containing said sample are transported from said tissue storage facility to a medical facility for transplantation into a subject.

19. The method of claim 10, wherein cells are collected from the combined washes of the sample, and said cells are tested for at least one of: cell number, cell viability, sterility, and colony forming units.

20. The method of claim 19, wherein at least two of the following are recorded:
i. date of receipt of sample;
ii. subject name or number;
iii. estimated sample weight;
iv. estimated cell number,
v. tested cell viability,
vi. tested sterility of sample;
vii. actual freezing parameters;
viii. date sample is frozen; and
ix. date sample is thawed.

21. Adipose tissue prepared according to the method of claim 8.

22. A syringe containing the adipose tissue of claim 21.
